(19) United States
(12) Patent Application Publication
(10) Pub. No.: US 2024/0025400 A1
(43) Pub. Date: Jan. 25, 2024

(54) FAR INFRARED DETECTION OF COMPACTED SNOW FOR LANE KEEPING

(71) Applicant: FORD GLOBAL TECHNOLOGIES, LLC, Dearborn, MI (US)

(72) Inventors: David A. Hiskens, Ypsilanti, MI (US); Brian G. Bennie, Sterling Heights, MI (US)

(21) Appl. No.: 17/868,903

(22) Filed: Jul. 20, 2022

(51) Int. Cl. B60W 30/12; B62D 15/02; B60W 30/02; B60W 50/14

(52) U.S. Cl. CPC B60W 30/12; B62D 15/025; B62D 15/029; B60W 30/02; B60W 50/14; B60W 2420/403; B60W 2552/10; B60W 2556/40; B60W 2552/50; B60W 2555/20; B60W 2554/4044; B60W 2554/406; B60W 2050/143; B60W 2710/20

(57) ABSTRACT

A steerable vehicle is configured to assist drivers who are traversing a snow-covered roadway. The vehicle uses perimeter sensors including a far-infrared camera to examine the roadway in front of the vehicle. The vehicle is equipped with a driver assistance system configured to operate the vehicle into a specified path or operate the vehicle by remaining in the specified path. The vehicle uses a controller to support a lane-keeping mode configured to be active while the roadway is snow-covered. The lane-keeping mode inspects images captured by the far-infrared cameras for tire tracks of previous vehicles and roadway edge features both which create compact snow and may assist in determining a skirting path or an adverse navigation area. The skirting path may be presented to the driver on a display or can be autonomously followed.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general vehicle driver assistance systems, and more specifically to identifying a drive path while traversing a snow-covered roadway.

Repeated traveling of vehicles along the same general path may create significant tire tracks in snow on the roadway. A forward facing far-infrared (FIR) camera can capture images which reveal these tire tracks. This compacted snow can provide better traction and is often used by drivers to identify a desired path for driving on the snow-covered road since earlier vehicles would have apparently been successful in navigating along that path.

Lane-keeping devices are present in many vehicles which use remote sensing such as Radar, Lidar, and visible-light cameras to detect vehicle position with respect to lane markers and to provide guidance which maintains vehicle operation within a currently occupied lane. The features normally detected to locate lane boundaries may become undetectable when the lanes on the roadway are snow covered. For example, painted lane lines, road edges, and curbs may become obscured in the snow.

An FIR camera detects the temperature and thermal emissivity of a scene, and has been used to differentiate between compacted and uncompacted snow. De facto “lanes” which arise when traffic traverses a roadway during or after a snowfall can provide a potential driving path to be targeted by a driver assistance system. For instance, Chase (U.S. Ser. No. 10/755,576) discloses the use of an FIR camera obtaining thermal images to find tire tracks on a snowy roadway in order to establish a driving centerline for a driver assistance system or for autonomous navigation. In some situations, however, tire tracks in snow might imply a path which may interfere with other traffic. For example, on a two-way, two-lane roadway on which the traffic flow is discontinuous, drivers may tend to shift their driving path toward the center of the roadway (e.g., to increase a margin of error with respect to the edge of the roadway). As a result, a single combined tire track may be created near the center of the roadway used by vehicles driving in both directions when no vehicle driving the opposite direction is present. As a result, the act of following of a set of tire tracks in the snow may not be consistently reliable.

### SUMMARY OF THE INVENTION

This invention has features which enable a driver to operate a vehicle according to detection of compacted tire tracks in snow in order to follow a path which skirts portions of a roadway which may contain vehicles moving along other obscured lanes.

In one aspect of the invention, a steerable vehicle comprises perimeter sensors configured to monitor an exterior of the vehicle including a far-infrared (FIR) camera capturing far-infrared images in a traveling direction of the vehicle. A driver assistance system is configured to initiate actions to steer the vehicle along a specified path. A controller has a lane-keeping mode active during times that a roadway being traversed by the vehicle is snow covered. The lane-keeping mode is configured to (A) inspect the far-infrared images for a roadway edge feature corresponding to an adverse driving area, (B) determine a skirting path relative to the roadway edge feature, and (C) provide the skirting path to the driver assistance system as the specified path.

In some embodiments, perimeter sensors monitor the exterior environment of the vehicle. The sensors include a far-infrared (FIR) camera obtaining FIR images. The invention may operate in a lane-keeping mode which inspects the FIR images for a roadway edge feature including a tire track and/or a curb or other vertical or sloping feature. Roadway edge features may be detectable because of discontinuities or because of different compaction of the vertical structures compared to flat surfaces. An opposite side of some roadway edge features may be correlated to adverse driving areas which are outside of the roadway, and are therefore to be avoided.

In some embodiments, the perimeter sensors include a visible camera which can be used to detect painted lane lines, roadway edge features, other vehicles, street gutters, or other assisting components of the driving environment whenever there are openings in the snow cover. In some embodiments, a locating device such as a GPS receiver device and a map database may be used to identify the number of lanes on the roadway and the direction of travel in each of these lanes.

A controller may determine a skirting path to be used by a driver assistance system as a specified path to follow. A driver assistance system may assist by autonomously driving the vehicle using the skirting path as guidance, automatically keeping the vehicle within the skirting path, returning the vehicle into the skirting path, or by physically, audibly, or visibly notifying the driver of corrective maneuvers if the vehicle wanders outside of the specified path. To notify the driver, some component of the vehicle such as the steering wheel may vibrate or the audio system may provide an audible alarm. A visual display panel may also provide the driver with the exterior environment view of the perimeter sensors overlayed by the skirting path as well as any detected adverse driving areas.

### BRIEF DESCRIPTION OF THE DRAWINGS

FIG. 1 is a schematic view of a vehicle traversing a snow covered, two-lane roadway with compacted tire tracks.

FIG. 2 is a block diagram showing a vehicle system according to a preferred embodiment.

FIG. 3 is a view of a far-infrared enhanced image captured by a far-infrared camera in which compacted tire tracks are clearly visible.

FIG. 4 represents a driver display screen having a far-infrared image supplemented with overlays highlighting a skirting path and an adverse driving area.

FIG. 5 is a flowchart showing one exemplary embodiment of a method to assist a driver traversing a snow-covered roadway.

FIG. 6 is a decision matrix showing possible actions to be taken based on available edge-type features on a roadway which have been detected using an FIR camera and other perimeter sensors.

### DETAILED DESCRIPTION OF PREFERRED EMBODIMENTS

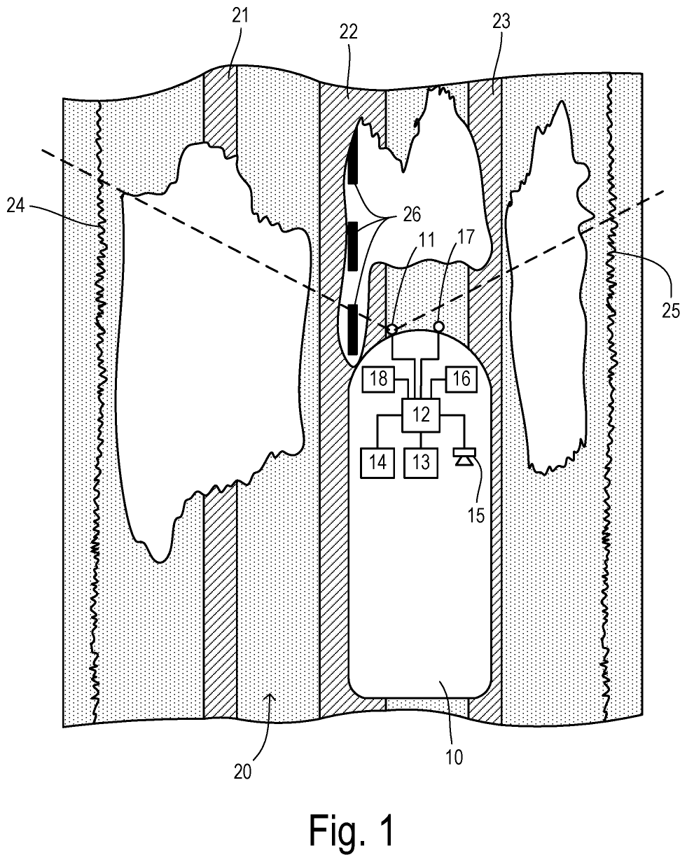

FIG. 1 shows a vehicle 10 with a controller 12 connected to an FIR camera 11 mounted on the vehicle which captures images in the traveling (forward) direction of the vehicle. A visual display panel 13 is placed in an interior of vehicle 10 to display various information from controller 12. Vehicle 10 has an instrument cluster 14 which can also display information from controller 12 to a driver such as steering commands or warnings relative to the projected path of vehicle 10. An internal speaker 15 communicates similar warnings from controller 12. An automated vehicle operator 16 represents any driver assist system or autonomous vehicle system which takes instructions from controller 12 and operates vehicle 10A. A perimeter sensor 17 can be any combination of a forward-facing visible camera, radar, LIDAR, etc., which provides controller 12 with additional information about the exterior environment of vehicle 10A. This information includes detecting other traffic and its direction of travel. A GPS device 18 provides controller 12 with a location of vehicle 10A.

FIG. 1 depicts vehicle 10 traversing a snow-covered two-lane roadway 20 with compacted tire tracks 21-23 and roadway edges 24 and 25 (e.g., a curb, shoulder, or other vertical or sloping feature). FIR camera 11 produces images which can distinguish between the uncompacted snow of roadway 20 and the compacted snow of tire tracks 21-23 and roadway edges 24 and 25. Controller 12 is configured to detect the trajectory and sizes of tire tracks 21, 22, and 23 based on the far-infrared images. Based on further analysis of the images and/or data from a map database or other perimeter sensors, controller 12 may further detect a number and direction of the total lanes of roadway 20. Controller 12 is further configured to assess which tire tracks can be associated with a particular lane and/or direction. When a two lane road has been identified and four separate tire tracks are detected, then controller 12 may associate the two leftmost tire tracks (in a righthand driving jurisdiction) with oncoming traffic. Although the two rightmost tire tracks may be a desirable path to travel upon, controller 12 may first evaluate the proximity of any oncoming traffic that may be following the two leftmost tire tracks.

Controller 12 uses as a first criterion for defining a travel path that any such oncoming traffic be kept away by a predetermined minimum distance when passing the host vehicle 10. Thus, controller 12 determines a skirting path that avoids any interference with the oncoming travel path of vehicles following the associated tire tracks. In the event that the locations of the rightmost tire tracks allows it, the skirting path can be defined such that vehicle 10 is steered to follow the rightmost tire tracks for enhanced traction.

In the case shown in FIG. 1 of a two-lane road with the two lanes for traveling in opposite directions wherein three tire tracks 21-23 are identified and wherein center tire track 22 is wider than the others, then controller 12 may recognize that tire track 22 has been alternately used by vehicles traveling in opposite directions. The skirting path is adjusted by controller 12 depending on the number of vehicles from different lanes of traffic using the same tire track and/or upon whether any opposing traffic is actually approaching vehicle 10.

In some embodiments, perimeter sensors may be used to detect visible lane lines 26 which may be revealed at intermittently spaced areas where the roadway is uncovered by snow. Visible lane markers can be used by controller 12 to verify or correct its identifications of roadway edges (e.g., tire track associations and curbs). Determination of a skirting path can be achieved with or without other additional perimeter sensors. Data from just FIR camera 11 may be sufficient to detect a roadway edge features or tire tracks which support creation of a skirting path to be specified for use by an advanced driver assistance system.

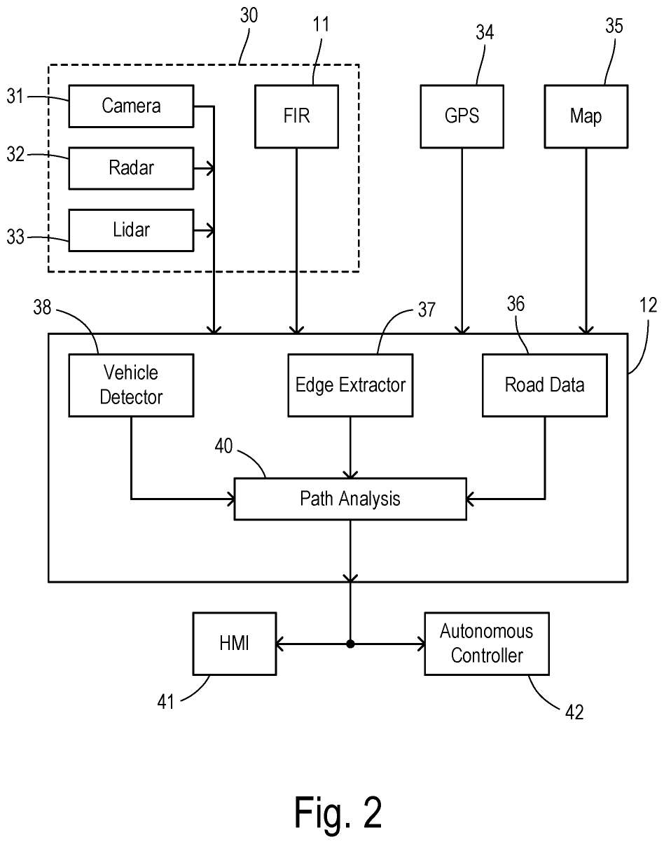

FIG. 2 shows portions of vehicle 10 in greater detail. Perimeter sensors 30 include far-infrared (FIR) camera 11 and optionally one or more of a visible light camera 31, radar 32, or lidar 33. A GPS receiver 34 provides instantaneous vehicle geographic coordinates of the location of vehicle 10 to controller 12 which uses the location data to index a map database 35 in order to determine road data 36. Road data 36 includes lane information for the roadway being traversed (e.g., number and direction of lanes). Controller 12 performs an edge extractor function 37 which utilizes data from sensors 30 to identify edge features such as edges of tire tracks in the snow, painted lane markers, and/or road boundaries such as curbs. Controller 12 may also perform a vehicle detector function 38 which uses perimeter sensor data to detect the presence or absence of other vehicles travelling in the same or different lanes. Based on road data 36, edge extractions 37, and vehicle detection 38, a path analysis function 40 is performed by controller 12 in order to determine a skirting path relative to the discovered roadway edge features in a way that avoids adverse driving areas. The skirting path is specified to a driver assistance system which is configured to initiate actions to steer the vehicle. The driver assistance system may include a human-machine interface (HMI) 41 and/or an autonomous vehicle controller 42 of a type which is known in the art.

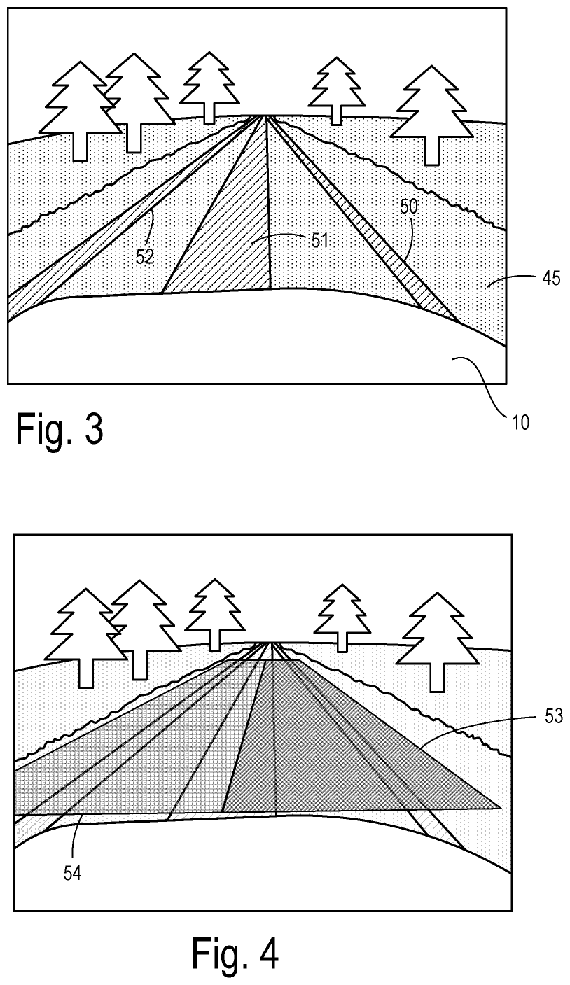

FIG. 3 depicts a graphical image which is displayed on a vehicle-mounted display panel based on a far-infrared streaming view for the purpose of assisting a driver to steer vehicle 10 along a specified (skirting) path. In the image, vehicle 10 is on a two-lane, two-way, snow-covered roadway 45. Compacted tracks 50, 51, and 52 have been created by vehicles previously traveling in both directions. Tire track 51 located near the middle of the roadway is shown with a greater lateral width as a result of being created by vehicles hugging the center of roadway 45 when traveling in both directions in the snowy conditions. If any oncoming vehicles are present, then the driver should avoid veering toward the left. In order to inform the driver of the location of the skirting path, the streaming view on the display panel can be supplemented with overlays to indicate a specified driving path and adverse driving areas to be avoided. Thus, FIG. 4 shows a graphical image for display on the display panel including FIR data collected from the FIR camera with overlayed indica from controller 12 to indicate (A) the skirting path via a desired driving area 53 comprising a first color tinting and (B) an adverse driving area 54 comprising a second color tinting which contrasts with the first color tinting. Driving a skirting path within desired driving area 53 avoids interference with adverse driving area 54. Tire track 51 which is a merger of many tire tracks formed by vehicles headed in both directions may be divided into both skirting path area 53 and adverse driving area 54 if tire tracks 50 and 52 are separated by a large enough distance. The image shown in FIG. 4 may be displayed on the visual display panel inside the vehicle interior to notify the driver.

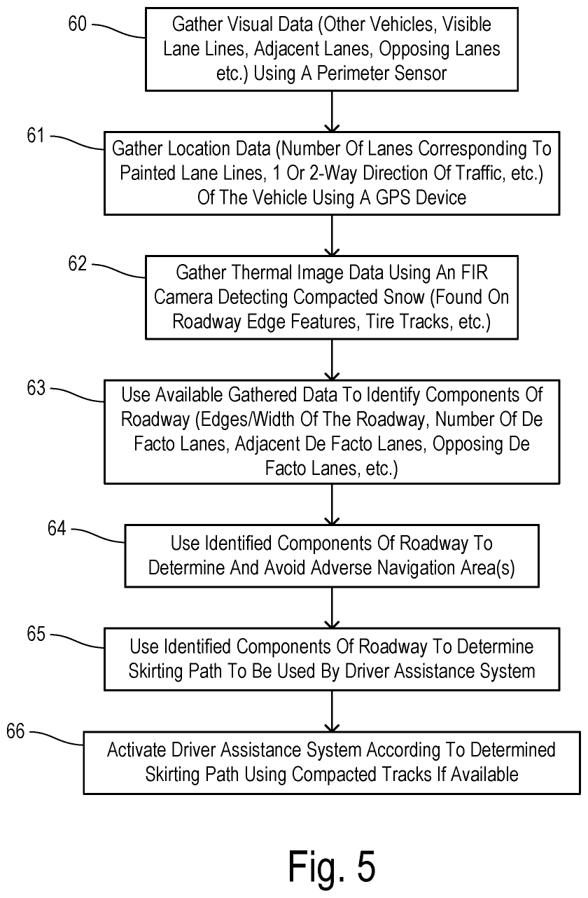

FIG. 5 shows a flowchart describing one preferred method. In step 60, perimeter sensors gather data including visible lane lines, roadway edge features, or oncoming vehicles. In step 61, a GPS device gathers location data to help characterize the roadway that the vehicle is traversing including the number and direction of lanes by cross-referencing location data with a map database. In step 62, an FIR camera collects thermal image data from FIR images. This thermal image data can show the differentiated thermal emissivity of uncompacted snow in comparison to the compacted snow from tire tracks or indicative of vertical sloping features near a roadway edge (e.g., a curb). In step 63, lane-keeping mode of a controller characterizes edge features for the corresponding roadway. Edge features may include the width of the roadway, any de facto lanes (the edges of which are identified by corresponding tire tracks), and corresponding direction of travel in the de factor lanes. In step 64, adverse driving areas are determined based on the edge features. For example, in the event of identifying the width of the roadway or even an edge of the roadway, the lane-keeping mode may determine the area outside of the edge as an adverse navigation area. Therefore, a driver assistance system may aid in avoiding these areas by keeping a vehicle inside areas which are not adverse navigation areas, by assisting a vehicle out of adverse navigation areas, or by using the adverse navigation areas as positional reference for providing navigational guidance. In step 65, any adverse navigation areas are used in determining a skirting path to be used by the driver assistance system. For example, the lane-keeping mode may utilize the location of an adjacent de facto lane to set the skirting path to generally parallel the de factor lane (or other edge feature). In step 66, the driver assistance system is activated to aid the driver, potentially altering the current position of the vehicle according to a specified path. The path may align the tires of the vehicle onto the compacted snow tire tracks if it is possible to do so while keeping within the skirting path.

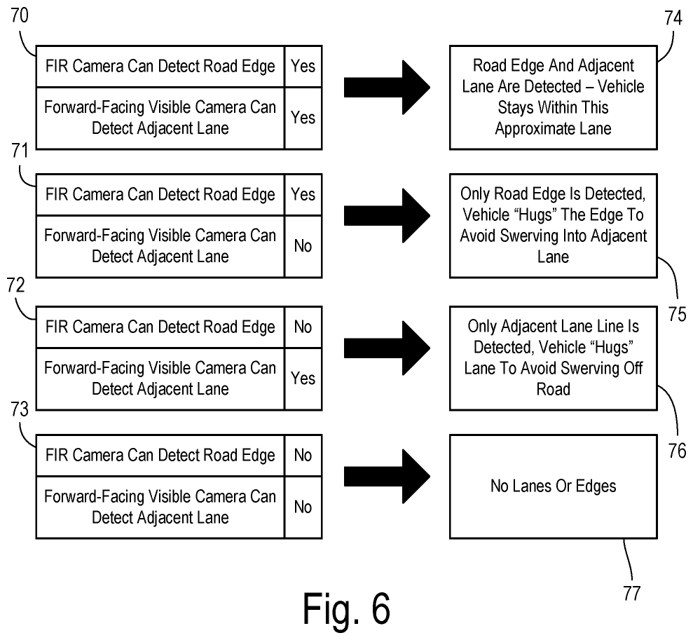

FIG. 6 depicts four scenarios 70-73 showing examples of potential actions of the driver assistance system based on available data. The scenarios a characterized by whether a road edge is detected in an FIR image and whether a camera or other perimeter sensor detects real features of an adjacent lane (e.g., painted lane lines). In a first scenario 70, the FIR camera is detecting road edge features and a forward-facing visible camera acting as perimeter sensor 17 is detecting an adjacent lane through visible lane lines or oncoming traffic. In response to scenario 70, an action 74 is taken wherein the skirting path determined is an approximate lane between the road edge and the adjacent lane. The driver assistance system can initiate actions to steer the vehicle within its approximate lane including driving on compacted tire tracks if available in the allowable range for the skirting path. In a second scenario 71, the FIR camera detects road edge features, but a forward-facing visible camera or perimeter sensor cannot detect an adjacent lane. In response to scenario 71, the driver assistance system will “hug” the detected edge feature (e.g., side of the roadway) to avoid an adjacent lane or opposing lane. In a third scenario 72, the FIR camera cannot detect road edge features, but a forward-facing visible camera or perimeter sensor can detect an adjacent lane. In response to scenario 72, the driver assistance system will “hug” the detected adjacent lane to avoid heading off of the roadway. In a scenario 73, the FIR camera cannot detect road edge features and the forward-facing visible camera or perimeter sensor cannot detect an adjacent lane. In response to scenario 73, the driver assistance system remains inactivate.

What is claimed is:

1. A steerable vehicle comprising:
perimeter sensors configured to monitor an exterior of the vehicle including a far-infrared (FIR) camera capturing far-infrared images in a traveling direction of the vehicle;
a driver assistance system configured to initiate actions to steer the vehicle along a specified path; and
a controller having a lane-keeping mode active during times that a roadway being traversed by the vehicle is snow covered, wherein the lane-keeping mode is configured to (A) inspect the far-infrared images for a roadway edge feature corresponding to an adverse navigation area, (B) determine a skirting path relative to the roadway edge feature, and (C) provide the skirting path to the driver assistance system as the specified path.

2. The steerable vehicle of claim 1 wherein the controller is further configured to detect directions of traffic in adjacent lanes.

3. The steerable vehicle of claim 2 wherein the driver assistance system adjusts a position of the vehicle according to the directions of traffic in adjacent lanes.

4. The steerable vehicle of claim 1 wherein the controller is further configured to detect a tire track being used by vehicles travelling in different lanes of traffic.

5. The steerable vehicle of claim 4 wherein the controller adjusts a position of the skirting path according to a number of vehicles travelling in different lanes of traffic while using a same tire track.

6. The steerable vehicle of claim 1 wherein the controller is further configured to distinguish a partial segment of a tire track as the skirting path.

7. The steerable vehicle of claim 1 wherein a position of the vehicle relative to the skirting path is presented to a driver by a vehicle notification system.

8. The steerable vehicle of claim 7 wherein the vehicle notification system is an interior audio system.

9. The steerable vehicle of claim 7 wherein the vehicle notification system is an interior lighting system.

10. The steerable vehicle of claim 1 wherein the driver assistance system uses data from the controller to maintain a position of the vehicle within the skirting path.

11. The steerable vehicle of claim 1 wherein the lane-keeping mode is further configured to inspect visible-light images for other vehicles and partially visible lane lines.

12. A method for locating and avoiding adverse navigation areas of a roadway while driving a motor vehicle comprising:
capturing visual images from the roadway using a perimeter sensor to gather visual data;
determining a location of the vehicle by using a GPS device to gather location data;
capturing thermal images from the roadway using an FIR camera to gather thermal image data;
determining a number of lanes present on the roadway by cross-referencing the location data with a map database;
extracting edge features using the thermal image data including tire tracks, curbs, and street edges;
determining at least one adverse navigation area in response to the edge features;
determining a skirting path for the vehicle to follow which avoids the adverse navigation area; and
providing driver assistance to drive the vehicle according to the skirting path.

13. The method of claim 12 wherein the driver assistance is comprised of:
notifying an occupant of the vehicle of both the skirting path and a relative location of the vehicle to the skirting path;
identifying position adjustments for the vehicle in order to avoid or exit the adverse navigation;
actuating a driver assist system to perform the position adjustments.

14. A method of steering a vehicle on a roadway at least partially covered by snow, comprising the steps of:
monitoring an exterior of the vehicle using a far-infrared (FIR) camera capturing far-infrared images in a traveling direction of the vehicle;
inspecting the far-infrared images for a roadway edge feature corresponding to an adverse navigation area;
determining a skirting path relative to the roadway edge feature;
providing the skirting path to a driver assistance system as a specified path;
initiating actions of the driver assistance system to steer the vehicle along the specified path.

15. The method of claim 14 wherein one of the edge feature is comprised of a tire track of compacted snow which is being used by vehicles travelling in a different lane of traffic.

16. The method of claim 14 wherein the actions of the driver assistance system include autonomously controlling a steering of the vehicle.

17. The method of claim 14 wherein the actions of the driver assistance system include notifying a driver of corrective maneuvers for steering the vehicle along the specified path.
